(19) United States
(12) Patent Application Publication
(10) Pub. No.: US 2010/0308724 A1
(43) Pub. Date: Dec. 9, 2010

(54) METHOD FOR THE PRODUCTION OF A SEALING REGION AND DISCHARGE LAMP PRODUCED BY SAID METHOD

(75) Inventor: Markus Stange, Berlin (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/675,402

(22) PCT Filed: Aug. 29, 2007
(86) PCT No.: PCT/EP2007/058953

§ 371 Date: Feb. 26, 2010

(51) Int. Cl. H01J 61/36; H01J 5/20; H01J 9/26; B05D 5/00; C25D 13/00

(52) U.S. Cl. 313/634; 313/317; 445/44; 427/58; 427/123; 204/471

(57) ABSTRACT

The invention relates to a method for the production of a sealing region of a discharge lamp, wherein the sealing region comprises a first (12) and a second (14) sealing region section and between the production of the first and the second sealing regions a shell (30) made of a material is applied to the sealed element.

### TECHNICAL FIELD

The present invention relates to a method for producing a sealing region, in particular a sealing region of a discharge vessel for discharge lamps, and to a discharge lamp, in particular a high-pressure discharge lamp, having a sealing region thereby produced.

### PRIOR ART

The prior art, for example EP 07 679 68, discloses the production of an electrical discharge lamp, in which at least one sealing region arranged on the discharge vessel is produced by forming a first seal and subsequently a second seal, the first seal consisting of a region of the discharge vessel material shrunk on itself and the second seal consisting of a pinch.

The shrunk seal fully encloses a connection between an electrode projecting into the discharge vessel and an electrical feed supplying the electrode with current, while the pinch only extends over the outer region of the electrical feed.

The electrical feed itself is advantageously a metal foil made of molybdenum, which includes a coating in order to minimize oxidation of molybdenum on contact with oxygen.

The production of such a coated molybdenum foil is known, for example, from DE 102 00 005.

A disadvantage with these known discharge lamps, however, is that using coated molybdenum foils entails the risk that the purity of the electrode will be contaminated or the interior of the discharge vessel will be polluted during production.

It is however also possible, as is known from the prior art, to use a foil made in two parts which has a coated side and an uncoated side, the uncoated side being connected to the electrode so as to prevent contamination of the electrode. Such a foil, however, is expensive and time-consuming to produce.

### SUMMARY OF THE INVENTION

It is therefore an object of the present invention to provide a method for producing a discharge lamp, which on the one hand is economical and on the other hand minimizes the risk of contamination during the production process.

This object is achieved by a method for producing a sealing region which includes a first sealing region section and a second sealing region section, wherein between the production of the first sealing region section and the production of the second sealing region section, a material encapsulation, in particular a coating, is applied onto an element to be fused into the sealing region, and/or a gas encapsulation is applied onto the element to be fused in.

Advantageously, the interrupted sealing process can ensure that contamination of the electrode or the discharge vessel by the coating material is prevented, since the formation of the first sealing region section tightly seals the discharge vessel and the connection between the electrical feed and the electrode. On the other hand the use of the subsequent coating, and the formation of the second sealing region section which follows this, can reliably prevent molybdenum oxidation processes.

The sealing per se may be carried out by all methods known from the prior art, in particular by local heating by means of a flame, or laser or plasma radiation or by forming a pinch, which methods may also be combined. It is likewise possible to produce the first and second sealing regions by different methods. In the context of this invention, a sealing region is thus intended to mean a region which in the finished lamp is in direct contact with the object to be fused in.

In addition to the coating or instead of the coating, it is furthermore advantageous to introduce a gas which is adapted to react with the electrical feed during the formation of the second sealing region section. Between the formation of the first sealing region section and the formation of the second sealing region section, it may also be advantageous to leave a region which is not fused together and can be filled with a gas having any desired composition.

The interrupted production process of the sealing region furthermore has the advantage that the formation of the second sealing region section is not subject to the same strict requirements as the formation of the first sealing region section. In this way, particularly when the second sealing region section is provided by pinching, processing can be carried out more rapidly and therefore more economically.

Other advantages and advantageous embodiments are presented in the dependent claims, the description and the drawings.

### BRIEF DESCRIPTION OF THE FIGURES

The invention will be explained in more detail below with the aid of the appended figures. The figures are not intended to restrict the protective scope to the exemplary embodiment presented by way of example in the figures, in which:

FIGS. 1A-1D show a schematic representation of the production steps according to the invention, the production steps being represented in the sub-figures A to D.

### PREFERRED EMBODIMENT OF THE INVENTION

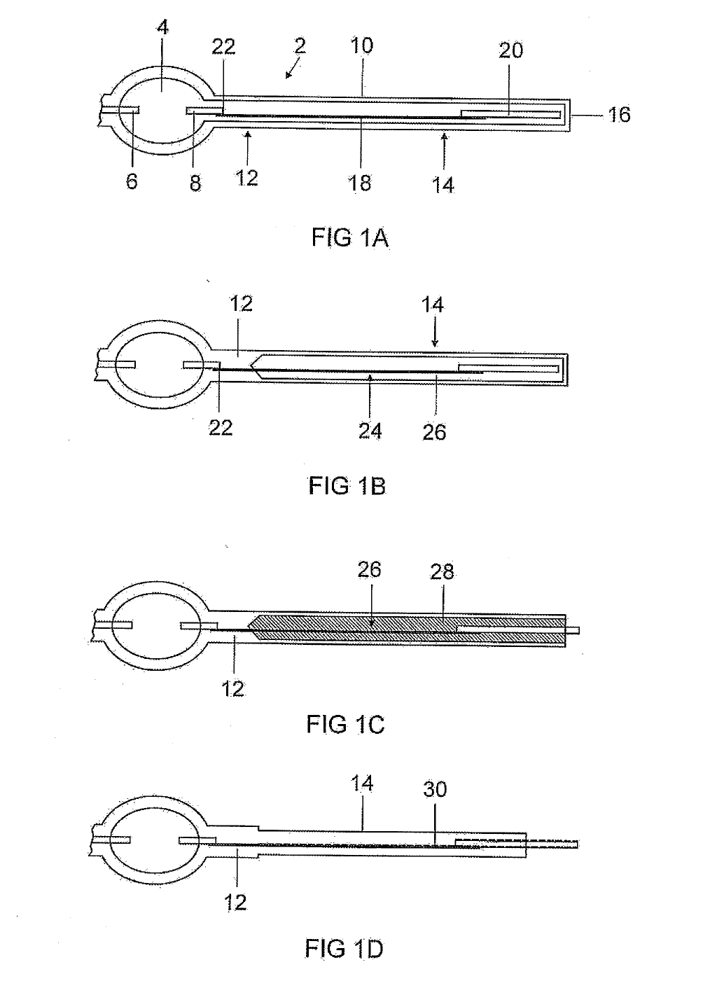

FIG. 1 schematically shows the method steps for producing a sealing region according to the invention in sub-figures A to D.

For the sake of simplicity, since discharge lamps are constructed symmetrically, the figures only show the right-hand side of a discharge vessel with a sealing region and electrical feeds arranged in it. The left-hand side is formed in a similar way.

Sub-FIG. 1A shows a discharge vessel 2 having a discharge region 4, into which electrodes 6, 8 project on mutually opposite sides. The discharge vessel is advantageously made of a quartz glass, at least 98 wt % of which consists of SiO₂.

FIG. 1A furthermore shows a tubular sealing region 10 which is arranged on the right of the discharge space and, after it has been fused, includes a first sealing region section 12 and a second sealing region section 14, although sealing region sections have not yet been formed in FIG. 1A. FIG. 1A also shows that the discharge vessel 2 has a termination 16 on its right-hand end. The termination may be provided by actual closure of the tubular sealing region. It is, however, also possible for the termination to be formed only indirectly, for example by connection to a valve in a production machine.

Electrical feed elements 18, 20 are introduced into the tubular sealing region 10; the electrical feed element 18 may preferably be formed as a molybdenum foil and the electrical feed element 20 may preferably be formed as a current-carrying pin, which may in turn provide an electrically conductive connection to a cap (not shown here) for discharge lamps.

Owing to the very high melting point of the quartz glass being used, the discharge vessel must be heated to from 2000 to 2500° C. in order to shape it. This limits the materials which can be used for the electrical feeds 18 and 20 and the electrodes 6, 8. Molybdenum is preferably used, although this has the disadvantage that molybdenum is oxidized very strongly by air at temperatures above about 300° C.

In order to protect molybdenum from this strong oxidation, a coating that prevents oxidation should advantageously be applied onto the electrical feed 18. In order to prevent or reduce oxidation, it is particularly advantageous to apply a chromium layer onto the molybdenum foil. Coatings which fulfill other functions are however also possible. Known coatings consist for example of oxides of yttrium, lanthanum, lanthanides, scandium, magnesium, calcium, strontium, barium, zirconium, hafnium, tantalum, titanium, thorium, aluminum, boron or silicon. Such coatings may inter alia increase the adhesive effect when forming a sealing region. Normally, however, these known coatings are applied onto the molybdenum foil before it is installed, and they can therefore cause contamination in the discharge vessel or on the electrodes.

So that neither the electrodes 6, 8 nor the discharge region 4 are contaminated, however, according to the invention an uncoated molybdenum foil is introduced into the tubular sealing region 10.

As represented in FIG. 1A, the discharge space 4 and the tubular sealing region 10 are still in communication with one another, i.e. the first sealing region section has not yet been formed in FIG. 1A. A fill, which is made to luminesce during operation of the discharge lamp by means of electrodes 6 and 8, may advantageously be introduced into this space.

In a first method step, which is shown in sub-FIG. 1B, the discharge region 4 is now closed off by producing the first sealing region section 12 so as to close the connecting space between the discharge region 4 and the tubular sealing region 10. The sealing region section 12 likewise includes a connecting region 22 between the electrode 8 and the electrical feed 18.

The sealing region section 12 is in this case produced for example by locally heating the quartz glass of the discharge vessel 2 around this region by means of flames, or laser or plasma radiation, so that it shrinks together in this heated region. This shrinkage of the heated quartz glass fully closes the discharge region 4 and also encloses the connecting point 22 between the electrode and the molybdenum foil in a vacuum-tight fashion. The first sealing region is furthermore pressure-stable, in order to be able to maintain the pressure prevailing in the discharge vessel 4. Instead of shrinkage, it is naturally also possible to produce the first sealing region by means of other methods, for example by means of pinching.

The shrunk region may cover up to half of the foil. It is however also possible for the first sealing region section 12 to end at a position very close to the discharge space 4. The remaining region of the foil 24, and the current supply pins 20, are not affected by this sealing process and a spatial separation 26 remains between the discharge vessel 2 and the electrical feed elements 18, 20.

In a method step subsequent to this, which is shown in FIG. 1C, the termination 16 of the discharge vessel 2 is opened and a coating material 28 can be introduced into the space 26 between the electrical feed elements 18, 20 and the discharge vessel 2.

The coating material 28 remains in the space 26 until a layer has been formed on the electrical feed elements 18, 20.

In order to form a chromium layer on the electrical feed elements 18, 20, for example, a chromium solution may be poured into the space 26, the chromium layer being formed by electrochemical deposition of chromium onto the electrical feed elements 18, 20 by connecting up the electrical feed elements 18, 20.

The material not consumed during the coating may subsequently be removed from the space 26.

After or instead of the coating process, a gas may be introduced into the region 26. Such a gas may on the one hand be an ignition gas which assists operation of the discharge lamp, although on the other hand it is also possible to introduce a gas which reactively assists the subsequent sealing step for forming the second sealing region section 14.

In a further method step, which is represented in sub-FIG. 1D, the second sealing region section 14 is formed by pinching or fusing. The electrical feed elements 18, 20 now have a coating 30 which reliably prevents oxidation of the current supply material being used.

In FIG. 1D, the two sealing region sections 12 and 14 are arranged immediately next to one another. It is however also possible for a spacing, which may contain a gas having any desired composition, to be left between the sealing region sections 12 and 14.

The fusing or pinching process per se may also be carried out under a protective gas.

A method has been disclosed for producing a sealing region of a discharge lamp, the sealing region having a first sealing region section and a second sealing region section, and a further method step being carried out between the production of the first sealing region and the production of the second sealing region.

1. A method for producing a sealing region, into which an element is fused and which comprises a first sealing region section and a second sealing region section, the method comprising:
applying an encapsulation made of a material onto the element between the production of the first sealing region section and the production of the second sealing region section.

2. The method as claimed in claim 1,
wherein the material encapsulation is a coating.

3. The method as claimed in claim 2,
wherein the coating is applied by introducing a coating solution.

4. The method as claimed in claim 2,
wherein the coating is applied by electrochemical deposition of a coating material.

5. The method as claimed in claim 1,
wherein the material encapsulation is a gas encapsulation consisting of an ignition gas.

6. The method as claimed in claim 1,
wherein the material encapsulation comprises a material which reactively assists the formation of the second sealing region section.

7. The method as claimed in claim 1,
wherein the first sealing region section is produced by at least one of shrinking the discharge vessel material on itself; pinching;
and fusing.

8. The method as claimed in claim 1,
wherein the second sealing region section is produced by at least one of shrinking; pinching: and fusing.

9. The method as claimed in claim 1,
wherein the element is an electrical feed, in particular a foil.

10. The method as claimed in claim 1,
wherein the element comprises molybdenum.

11. The method as claimed in claim 2,
wherein a chromium coating is applied onto the element.

12. The method as claimed in claim 2,
wherein the coating is adapted to provide oxidation protection.

13. The method as claimed in claim 1,
wherein the discharge vessel material is quartz glass.

14. The method as claimed in claim 1,
wherein the discharge vessel comprises at least one electrode and the element is configured as an electrical feed for this electrode and is connected to the electrode, the first sealing region section fully enclosing the connection between the electrode and the electrical feed.

15. A discharge lamp, comprising:
a discharge vessel which comprises the sealing region into which an element is fused and which comprises a first sealing region section and a second sealing region section,
wherein the material encapsulation and the first and second sealing region sections are produced by a method, the method comprising:
applying an encapsulation made of a material onto the element between the production of the first sealing region section and the production of the second sealing region section.

16. The discharge lamp as claimed in claim 15,
wherein the material encapsulation is a coating.

17. The discharge lamp as claimed in claim 16,
wherein the coating comprises chromium.

18. The discharge lamp as claimed in claim 15,
wherein the element fused in comprises an electrical feed which supplies current to an electrode projecting into the discharge vessel.

19. The discharge lamp as claimed in claim 15,
wherein the element is a molybdenum foil.

20. The discharge lamp as claimed in claim 18,
wherein the first sealing region section fully encloses the connection between the electrode and the electrical feed.

21. The discharge lamp as claimed in claim 16,
wherein the coating is adapted to provide oxidation protection.

22. The discharge lamp as claimed in claim 15
wherein the discharge vessel material is quartz glass.

23. The discharge lamp as claimed in claim 15,
wherein the material encapsulation is a gas encapsulation consisting of an ignition gas.

24. The discharge lamp as claimed in claim 15,
wherein the material encapsulation comprises a material which reactively assists the formation of the second sealing region section.
